(19) United States
(12) Patent Application Publication
(10) Pub. No.: US 2025/0187125 A1
(43) Pub. Date: Jun. 12, 2025

(54) Method and Manufacturing Installation for Producing a Plurality of Workpieces

(71) Applicants: Carl Zeiss AG, Oberkochen (DE); Carl Zeiss Digital Innovation GmbH, Dresden (DE)

(72) Inventors: Nils Haverkamp, Oberkochen (DE); Christian Hoerr, Oberkochen (DE); Franz-Georg Ulmer, Oberkochen (DE); Sladjan Matic, Oberkochen (DE); Christian Wissmann, Oberkochen (DE); Daniel Goersch, Oberkochen (DE)

(21) Appl. No.: 19/055,193

(22) Filed: Feb. 17, 2025

Related U.S. Application Data
(63) Continuation of application No. PCT/EP2023/068020, filed on Jun. 30, 2023.

(30) Foreign Application Priority Data
Aug. 18, 2022 (DE) 102022120900.8
Sep. 30, 2022 (DE) 102022125378.3

(51) Int. Cl. B23P 19/04; G05B 19/418

(52) U.S. Cl. CPC B23P 19/04; G05B 19/4183; G05B 2219/42124

(57) ABSTRACT

A method for producing workpieces using a manufacturing installation includes obtaining a data set defining desired workpiece characteristics of workpieces. The method includes producing a first workpiece in first successive manufacturing steps using a first manufacturing machine. The method includes repeatedly recording first process parameters during the first successive manufacturing steps. The method includes mapping the first process parameter sequences onto the first successive manufacturing steps to obtain first sequential mapping data. The method includes inspecting the first workpiece using a metrology device to obtain actual first workpiece characteristics. The method includes comparing the actual first workpiece characteristics with the desired workpiece characteristics to determine deviations. The method includes determining second control commands based on the deviations, at least one of the first control commands and the data set, and the first sequential mapping data. The method includes producing a second workpiece using the second control commands.

### CROSS-REFERENCE TO RELATED APPLICATIONS

This application is a continuation of International Patent Application No. PCT/EP2023/068020 filed on Jun. 30, 2023, which claims priorities to DE 10 2022 120 900.8 filed Aug. 18, 2022 and DE 10 2022 125 378.3 filed Sep. 30, 2022. The entire disclosures of the above applications are incorporated by reference.

### FIELD

The present invention relates to a method for producing a plurality of workpieces using a manufacturing installation that comprises at least one manufacturing machine controlled by a respective machine controller. The invention further relates to a manufacturing installation for producing a plurality of workpieces using the method.

### BACKGROUND

In many branches of industry, it can currently be observed that increased efforts are made to integrate one or more metrology devices for production quality monitoring into the manufacturing installation or even directly into a manufacturing machine. This has several reasons. For instance, there is a desire to avoid or reduce specific infrastructure for metrology devices, such as dedicated measuring room infrastructure having controlled temperature, humidity or even clean or grey room conditions, low vibration etc. Specific infrastructure for metrology is expensive. Moreover, dedicated measuring rooms are often remote from the manufacturing area, which makes workpiece logistics more difficult.

A further downside is that remote measuring rooms often generate measurement results with a time delay that is too large to be effectively used for closed-loop manufacturing control. Time-to-result is often significantly longer than production cycle times or period lengths of production process fluctuations. In addition, highly qualified personnel is often required for operating the measuring rooms.

Notwithstanding, quality control has been of utmost interest in industrial manufacturing processes for years in order to achieve both cost efficient production and high product acceptance on the customer's side. There are many concepts and approaches for establishing quality control processes in the industrial manufacture of workpieces.

By way of example, U.S. Pat. No. 11,249,458 B2 discloses a control system including a controller that controls machining of a workpiece, and including a photographing device that photographs an image of the workpiece under machining operation. The controller generates a three-dimensional model of the workpiece under machining operation based on the acquired image, compares the generated three-dimensional model and a three-dimensional model generated by a machining simulation with each other, and determines a presence or absence of a machining defect based on a result of the comparison. When the machining defect is present and re-machining is possible, a setting is modified depending on a cause of the machining defect and additional machining is executed based on the modified setting.

U.S. Pat. No. 11,049,236 B2 discloses a system and method for performing real-time quality inspection of objects. The system and method include a transport to move objects being inspected, allowing the inspection to be performed in-line. At least one optical acquisition unit captures optical images of the objects being inspected. The optical images are matched to CAD models of objects, and the matched CAD model is extracted. A laser with an illumination light beam has a wavelength in the violet or ultraviolet range and conducts scans of the objects, which are formed into three-dimensional point clouds. The resulting point cloud data are compared to the extracted CAD model data for each object, where CTF are compared to user input or CAD model information and the object is determined to be acceptable or defective based on the extent of deviation between the point cloud or point cloud data and the CAD model or CAD model data.

US 2021/0208568 A discloses a manufacturing system comprising: a communication module for receiving a three-dimensional model and control commands including manufacturing instructions for the manufacturing machine with respective reference values, tolerance values, and/or intervention tolerance values; a manufacturing module, wherein the model, the instructions, and the commands are used to manufacture an object; a calculating module using the three-dimensional model and the manufacturing instructions to calculate the control commands; and a measuring device having a communication module for receiving the three-dimensional model, a capture module using sensors to measure the manufactured object, captured for the reference values and/or the tolerance values and/or intervention tolerance values, and a checking module, wherein a divergence of the measured values from the applicable manufacturing reference values and an exceeding of the associated manufacturing tolerance values and/or the associated intervention tolerance values result in a control signal.

U.S. Pat. No. 9,383,742 B2 discloses a system and method for error compensation in positioning a complex-shaped gas turbine engine part during manufacturing thereof with a machine. Theoretical measurements for a plurality of control points on the part are first retrieved. Actual measurements for the control points are then acquired in a coordinate system of the machine. If an error between the actual and theoretical measurements is beyond a tolerance, a transformation matrix is computed. The transformation matrix represents a transformation to be applied to the coordinate system to adjust a pose thereof for compensating the error. The transformation matrix may be computed and applied to the coordinate system iteratively until the actual measurements are brought within tolerance. A machining program may then be generated for manufacturing the part accordingly.

EP 3 045 992 A1 discloses a method using a feedback loop for compensating errors occurring in a production process. The method comprises generating actual property data of at least one sample object produced in a production assembly according to a production model, performing a nominal-actual value comparison thereby generating deviation data, and automatically creating an adapted production model based on nominal property data and on the deviation data. The adapted production model is useable in an adapted production process for producing an adapted object in the production assembly, and differs from the nominal property data so that the errors occurring in the production process are at least partially compensated in the adapted production process.

U.S. Pat. No. 6,975,918 B2 discloses a production system for the series manufacture of products, comprising a processing device which, as a function of control commands, actuates a tool for processing one of the products, a measuring device for the automatic measuring of a geometric actual dimension at one of the processed products, a correcting device which is coupled to the processing device and to the measuring device and which compares the actual dimension with a preset target dimension which lies within a tolerance interval. The correcting device intervenes in a corrective manner in the control commands of the tool if the actual dimension lies outside an intervention interval which lies within the tolerance interval.

U.S. Pat. No. 11,036,203 B2 discloses a fabrication system for fabricating a three-dimensional object using processing circuitry. The processing circuitry estimates, according to a fabrication condition and fabrication data, a three-dimensional object to be fabricated according to the fabrication data and corrects the fabrication data according to an estimation result of the three-dimensional object estimated by the processing circuitry.

U.S. Pat. No. 8,090,557 B2 discloses a method for operating an industrial processing machine, a production machine or a manipulation robot. At least part of the operation of the industrial machine is simulated with the aid of a simulation model and the simulated results and real-time data from the operation of the industrial machine are stored. The simulation can be carried out in the industrial machine and if this is the case a parametric representation of the simulation model can be at least partly produced using a unit for this purpose. To produce the parametric representation, a data-systems connection can be created between the industrial machine and the unit, by means of an Intranet and/or an Internet connection. In addition, the simulation can be carried out in an external simulation unit, the latter having a data-systems connection to the industrial machine by means of an Intranet and/or an Internet connection.

WO 2018/204410 discloses a system comprising a first data link to a manufacturing system configured to create a run of parts based on a common engineering schematic, comprising a second data link to a metrology device configured to measure at least some parts in the run of parts to generate measurement data representing a physical shape of each part of the at least some parts, and comprising a machine learning system including one or more processors in communication with a computer-readable memory storing executable instructions, wherein the one or more processors are programmed by the executable instructions to at least: access a neural network trained, based on measurement data of past parts in the run of parts, to make a prediction about a future part in the run of parts; forward pass the measurement data through the neural network to generate the prediction about the future part in the run; and determine whether to output instructions for adjusting operations of the manufacturing system based on the prediction.

U.S. Pat. No. 10,180,667 B2 discloses a measurement technique integrated into a manufacturing machine in which the measurement results are interpreted by a trained artificial intelligence (AI). The AI determines new nominal control data on the basis of the measurement results.

Some of the prior art approaches aim to make corrections before a workpiece is actually produced. In other words, they try to implement some sort of forward error correction using knowledge gained from a previously produced workpiece in the production process of a subsequently produced workpiece. Such preemptive error correction appears very promising in order to optimize the efficiency and the output of a real, non-ideal manufacturing installation. Unfortunately, industrial manufacturing processes and installations can be very complex and it is often difficult to clearly identify all the causes and effects that can lead to undesired production errors and product deficiencies. It is therefore common practice to operate a real manufacturing installation with process parameters that are carefully selected in such a manner that desired product characteristics are likely met even if the actual production run is affected in an unexpected manner. In other words, it is accepted best practice to not push a manufacturing installation to its limits if high product quality is a major goal.

Preemptive error correction becomes even more difficult if the number of workpieces to be produced, i.e. the batch size, is small. It is particularly difficult to estimate the causes and effects leading to production errors if only a small number of samples is available. On the other hand, it is more and more desirable to produce workpieces in small batch sizes (up to a batch size of one) in order to enable customer specific variations.

The background description provided here is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

In view of the above, it is an object of the present invention to provide an improved manufacturing method and installation for efficiently producing workpieces with high product quality. It is a further object to provide a method and installation that allow an efficient production of workpieces both in large and small batch sizes. It is yet another object to provide a manufacturing method and installation that allow efficient production of workpieces by exploiting knowledge gained during previous production runs.

According to a first aspect, there is provided a method for producing a plurality of workpieces using a manufacturing installation that comprises a first manufacturing machine having a first moveable machine element, a first machine controller configured to control the first moveable machine element, and a metrology device configured to determine actual characteristics of a produced workpiece, the method comprising the steps of
obtaining a data set defining desired workpiece characteristics of the plurality of workpieces,
producing a first workpiece from the plurality of workpieces in a plurality of first successive manufacturing steps using the first manufacturing machine, wherein the first machine controller controls the first moveable machine element along a plurality of first movement paths using a plurality of first control commands determined on the basis of the data set,
repeatedly recording a plurality of first process parameters during the plurality of first successive manufacturing steps in order to thereby obtain a respective first process parameter sequence for each first process parameter of the plurality of first process parameters,
mapping the plurality of first process parameter sequences onto the plurality of first successive manufacturing steps in order to obtain first sequential mapping data, the first sequential mapping data associating each first control command from the plurality of first control commands with first process parameters recorded at the time when the respective first control command was executed,
inspecting the first workpiece using the metrology device in order to obtain actual first workpiece characteristics,
comparing the actual first workpiece characteristics with the desired workpiece characteristics in order to determine deviations between the actual first workpiece characteristics and the desired workpiece characteristics,
determining a plurality of second control commands on the basis of the deviations, on the basis of at least one of the plurality of first control commands and the data set, and on the basis of the first sequential mapping data, and
producing a second workpiece from the plurality of workpieces using the manufacturing installation and the plurality of second control commands.

According to a second aspect, there is provided a manufacturing installation for producing a plurality of workpieces, comprising
a first manufacturing machine having a first moveable machine element,
a first machine controller configured to control the first moveable machine element in order to produce a workpiece in a plurality of first successive manufacturing steps, wherein the first machine controller controls the first moveable machine element along a plurality of first movement paths using a plurality of first control commands determined on the basis of a data set defining desired workpiece characteristics,
a plurality of first process parameter detectors configured to record a plurality of first process parameters during the plurality of first successive manufacturing steps in order to thereby obtain a respective first process parameter sequence for each process parameter of the plurality of first process parameters,
a first correction controller associated with the first machine controller, and
a metrology device configured to determine actual characteristics of a produced workpiece,
wherein the first correction controller is configured to
map the plurality of first process parameter sequences onto the plurality of first successive manufacturing steps in order to obtain first sequential mapping data, the first sequential mapping data associating each first control command from the plurality of first control commands with first process parameters recorded at the time when the respective first control command was executed,
obtain deviations between the actual workpiece characteristics and the desired workpiece characteristics,
generate first error correction commands on the basis of the deviations and on the basis of the first sequential mapping data, and
determine a plurality of modified control commands for the first machine controller on the basis of the first error correction commands.

The new method and manufacturing installation thus use information obtained during and after an actual production run for optimizing further production runs following the actual production run. More particularly, a first workpiece produced with the new manufacturing installation is inspected in order to determine actual first workpiece characteristics. The actual first workpiece characteristics are compared to desired workpiece characteristics, which were used as a basis for the actual production run. By way of example, the desired workpiece characteristics may be derived from a data set defining dimensional and/or geometrical characteristics in structured form, such as a CAD data set or any other data set that can be related to or derived from a CAD data set. The data set may advantageously comprise tolerance indications defining how far the actual workpiece characteristics may deviate from nominal workpiece characteristics in absolute and/or relative terms. Geometrical characteristics may include or define the surface shape of the workpiece. Dimensional characteristics may include or define dimensions including the size of one or more workpiece features, such as the diameter of a bore for instance, the spacing between two or more workpiece features such as the distance between two workpiece edges, and/or surface roughness.

The comparison provides information about whether or not the produced workpiece has the desired workpiece characteristics and, if not, which desired workpiece characteristics are not obtained. In some exemplary embodiments, the deviations may include information as to how far and/or in which regions and/or in which features the produced workpiece deviates from the desired workpiece characteristics.

It has to be understood that deviations may occur for a variety of reasons and there may exist various linear or non-linear dependencies between causes and effects that finally result in individual deviations. By way of example, the following factors may play a role in assessing causes and effects that lead to individual deviations: individual characteristics of the manufacturing installation such as structure, type and size of a machine tool; individual operating parameters of the manufacturing installation during the production run, such as movement speed and/or acceleration of the machine element; individual environmental parameters such as temperature and/or humidity; historical operating parameters resulting in individual wear and tear; workpiece material parameters; and/or the number, instant of time and/or manner of individual operator interventions during a production run. The dependencies appear complex and it is difficult to identify each and every cause of a deviation in conventional manufacturing installations.

Usually, a workpiece can be inspected only at the end of a production run or at predefined or preselected interruptions during a complete production run. Interruptions in a production run can cause deviations of their own, because an interruption of a substantially continuous production process can lead to changes in the parameters that affect the outcome of the production process. In general, it is rarely possible to inspect a workpiece continuously, directly and in real-time, while the workpiece is being processed. As a result, production errors occurring during a production run often accumulate, which makes it even more difficult to identify the source of a production error.

The new method and manufacturing installation advantageously establish an improved feedback loop by repeatedly recording the plurality of process parameters during the plurality of successive manufacturing steps in order to thereby obtain a respective process parameter sequence for each process parameter that could be of interest. The parameter sequences provide information about the temporal development of the respective process parameters during the production run. Advantageously, the new method and manufacturing installation then map the respective parameter sequences onto the plurality of manufacturing steps in order to thereby obtain mapping data that allow to correlate the series of manufacturing steps and the various process parameters, which process parameters represent the respective individual situation in which the respective manufacturing steps have been carried out.

By associating each first control command from the plurality of first control commands with the respective process parameters recorded at the time when the respective first control command was executed, and by additionally taking into account the deviations, the complex cause-and-effect relationship between the production process and the production outcome can be selectively examined. History information derived from the recorded process sequences help to analyze various production effects that resulted in a cumulative deviation at the end of the production run. The more information is collected during an actual production run and, preferably, previous production runs, the better can the cause-and-effect relationship be estimated and/or modelled, may it be numerically, including but not limited to a supervised, a non-supervised or, preferably, a reinforced deep learning algorithm and/or by any suitable parametric or non-parametric approach.

Advantageously, the second control commands are determined in such a manner that the deviations are reduced and preferably minimized in the next production run. By way of example, movement speed, acceleration and/or movement distance of a process tool, such as a cutting tool, a grinder or a laser, may be modified in comparison to a previous production run for the same type of workpiece in order to decrease a deviation found on the previously produced workpiece. The new manufacturing method and installation thus use an improved forward error correction by recording process parameter time sequences and exploiting them in order to get a timely resolved and thereby improved feedback. It should be understood that, in some exemplary embodiments, the second control commands may differ from the first control commands primarily or exclusively in terms of numerical control parameters including but not limited to travel distance, travel speed and/or acceleration of the moveable machine element along one or more movement axes. Moreover, a numerical control parameter of a control command may correspond to a process parameter, which is repeatedly recorded during the production run, in terms of its physical quantity. By way of example, a control command may include a machine instruction, such as what is known as G-code or M-code for a numerical controller, and include an individual numerical control parameter. By way of example, M3 S1000 may be an M-code for starting and accelerating a tool spindle to rotate with 1000 revs/min clockwise. A corresponding process parameter, the temporal sequence of which is recorded during the production run, may then be actual revolutions per minute of the tool spindle.

By recording and mapping the time sequences of the actual process parameters, the new manufacturing method and installation implement repeated in-process measurements while the workpiece is produced. The process parameters may not directly reflect workpiece characteristics, because they do not necessarily involve measurement values on the workpiece itself. However, the process parameter sequences represent the processing environment that leads to the final workpiece characteristics over the time. In other words, recording and mapping the process parameter time sequences establishes some sort of indirect or virtual in-process measurements of the workpiece. A process logbook is created and mapped onto the control commands (including numerical control parameters used at a respective instant of time) such that it can be determined which part of the produced workpiece was manufactured under which conditions. The knowledge gained from these in-process measurements helps to optimize the production process in a new manner. As a result, the manufacturing can be pushed more to its limits even if high product quality is a major goal, and a plurality of objects can be efficiently produced. Production errors can be reduced by using modified control commands in an efficient manner.

In a preferred refinement, the manufacturing installation comprises a second manufacturing machine having a second moveable machine element and a second machine controller configured to control the second moveable machine element, and the second workpiece is produced using the second manufacturing machine and the second machine controller. The manufacturing installation thus may further comprise a second manufacturing machine having a second moveable machine element, a second machine controller configured to control the second moveable machine element during a plurality of second successive manufacturing steps, and a second correction controller associated with the second machine controller, wherein the second correction controller is configured to obtain and map a plurality of second process parameter sequences onto the plurality of second successive manufacturing steps in order to obtain second sequential mapping data, and to determine a plurality of modified second control commands for the second machine controller on the basis of the second sequential mapping data.

In this refinement, knowledge gained from the first production run using a first manufacturing machine is advantageously transferred and used for a production run on a second machine. The second machine may advantageously be of the same type and/or the same brand as the first manufacturing machine, although this need not be the case in some exemplary embodiments. Even if the first and second manufacturing machines are of different type and/or brand, knowledge gained from a recent production run on the first manufacturing machine can advantageously be exploited for preemptive error corrections in the second production run. By way of example, detecting a correlation between dimensional production errors in a certain area of the first workpiece and a temperature increase in that area can be used in order to modify the corresponding control commands (including numerical control parameters) in such a manner that the workpiece area gets more cooling time during the process, and this knowledge can advantageously be used on the second manufacturing machine as well. The refinement further improves efficient manufacture of a plurality of workpieces by extending the new concept to a plurality of coworking machines.

In a further preferred refinement, the first manufacturing machine is located at a first manufacturing site and the second manufacturing machine is located at a second manufacturing site remote from the first manufacturing site, wherein individual process parameter sequences are recorded separately on the first and second manufacturing sites, and wherein the plurality of second control commands are determined based on the individual process parameter sequences from both the first and the second manufacturing sites.

This refinement extends the afore-mentioned concept even further by automatically transferring knowledge gained from the first production run using a first manufacturing machine to a second manufacturing machine that is located at a different location. In some exemplary embodiments, the first and second manufacturing machines may be located in different buildings, in different cities or different regions of a country or even in different countries. The refinement greatly improves efficient manufacture of a plurality of workpieces by extending the new concept to a plurality of manufacturing machines operated at very different locations. By taking into account the process parameter sequences from both the first and second manufacturing sites, the knowledge database is largely increased, while individual and appropriate corrections can be made using knowledge gained from the remote site.

In another refinement, the manufacturing installation further comprises a high level comparator operationally connected to the first and second correction controllers, wherein the high level comparator is configured to determine higher level error correction commands both for the first machine controller and for the second machine controller on the basis of the first and second sequential mapping data. In some exemplary embodiments, the high level comparator may issue operational instructions and/or warnings to operating personal of the machine installation based on the information gathered from the plurality of connected manufacturing machines and/or the plurality of process parameter sequences. By way of example, the high level comparator may issue an instruction to check or adapt one or more of the recorded process parameters, such as operational temperature, tool speed, amount of cooling liquid used etc. The high level comparator advantageously collects manufacturing information from various manufacturing machines, which may be located in different cities, regions or countries, and accumulates and compares all this information in order to automatically optimize the production runs on each or many of the various connected manufacturing machines. The overall system benefits from the various production runs and is automatically optimized. Production efficiency is even further increased.

In a further preferred refinement, the method further comprises a step of producing a third workpiece from the plurality of workpieces on either the first manufacturing machine or the second manufacturing machine, wherein an individual process decision is made in order to assign the step of producing the third workpiece to either the first manufacturing machine or the second manufacturing machine, and wherein the individual process decision is based on the individual process parameter sequences from both the first and second manufacturing sites.

In this refinement, knowledge gained from previous production runs is advantageously used in order to make well founded decisions on which manufacturing machine from the plurality of manufacturing machines the next production run can be most efficiently and correctly executed. The refinement even further increases production efficiency and product quality.

In a further preferred refinement, the step of inspecting comprises transferring the first workpiece from the manufacturing machine to the metrology device using an automated handling apparatus. Accordingly, the manufacturing installation preferably comprises an automated handling apparatus configured to transfer the first workpiece from the manufacturing machine to the metrology device.

This refinement is advantageous, because it increases the repeatability of the measurement process and thus the reliability of the actual workpiece characteristics determined. Preferably, the handling apparatus and the metrology device operate on the basis of automated inspection plans that are derived from the data set defining the desired workpiece characteristics. This further improves the efficiency of the new method and manufacturing installation.

In another preferred refinement, the step of inspecting comprises generating formatted 3D point cloud data representing a plurality of measurement points on the first workpiece, and the step of comparing comprises fitting a CAD representation of the first workpiece into the formatted 3D point cloud data using a best-fit algorithm, including any well-defined alignment procedure (RPS, 3-2-1, . . . ).

In this refinement, the workpiece is advantageously represented by a plurality of 3D coordinate points relative to a predefined coordinate system. Fitting a CAD representation of the ideal, desired workpiece into the formatted 3D point cloud data allows to detect deviations very efficiently. The fitting may be restricted to selected parts or regions of the actual workpiece, especially parts/regions that are of major importance for the product quality, such as predefined workpiece features. In some preferred exemplary embodiments, the steps of inspecting and fitting may be carried out using metrology software tools as provided by Carl Zeiss Industrielle Messtechnik GmbH, Germany, under the brand names Calypso, Caligo, ZEISS Quality Suite or GOM Inspect. The Calypso metrology tool is especially well suited for measuring and evaluating regular forms, such as circular bores, while the Caligo tool is especially well suited for measuring and evaluating free-form surfaces.

In another preferred refinement, a workpiece main axis of the first workpiece is estimated, preferably by using a point-density analysis of the formatted 3D point cloud data, and the formatted 3D point cloud data is pre-aligned prior to the fitting using the workpiece main axis.

This refinement also increases the efficiency of the new method and manufacturing installation, because it accelerates the comparison step. Deviations between the actual workpiece characteristics and desired workpiece characteristics can be detected faster. Point-density analysis calculates the density of point features around predefined cells. In other words, mutual neighborhood relations are evaluated. Such an analysis is readily available and helps to detect main axes of the actual workpiece even without prior knowledge about the workpiece. In some exemplary embodiments, the pre-alignment using point-density analysis is used for determining pre-alignment positions along translational axes, while pre-alignment about rotational axes is determined using singular-value decomposition.

In another preferred refinement, a plurality of different inspection plans are assigned to different areas of the formatted 3D point cloud data, and the plurality of different inspection plans are executed in parallel.

This refinement also helps to accelerate the comparison step and thus to increase the efficiency of the new method and manufacturing installation.

In another preferred refinement, determining the plurality of second control commands comprises partitioning at least one of the 3D point cloud data and the first workpiece into a plurality of workpiece partitions and determining respective second control commands for each of the workpiece partitions separately.

This refinement is another advantageous improvement because it allows to individually optimize error compensation in various areas of the workpieces. Workpiece quality can efficiently further be improved.

In another preferred refinement, producing the second workpiece comprises recording a plurality of second process parameter sequences during a plurality of second successive manufacturing steps, selecting a subset of second control commands from the plurality of second control commands at a time when the subset of second control commands has not yet been executed during the plurality of second successive manufacturing steps, modifying the subset of second control commands on the basis of the plurality of second process parameter sequences in order to obtain modified second control commands, and controlling the moveable machine element using the modified second control commands.

This refinement introduces in-process and real time error compensation during a running production process by advantageously exploiting the prior knowledge and the recording of current process parameters. The refinement makes beneficial use of “virtually measuring” the workpiece while it is being produced on the basis of the established correlations between the process parameters and the cumulated deviations. High quality output of the new manufacturing installation can even further be increased.

In another preferred refinement, producing the second workpiece is terminated if it is determined that the modified second control commands exceed a predetermined threshold criterium.

This refinement also helps to improve the efficiency of the new method and manufacturing installation by avoiding unnecessary machine use. Based on the modified second control commands and one or more predetermined threshold criteria, early termination of an unpromising production process can easily be implemented. By way of example, the predetermined threshold criterium may define or comprise one or more parameter values contained in or related to the modified control commands, such as an amount of additional travel that the moveable element would have to go in order to compensate a dimensional production error.

In another preferred refinement, the second workpiece is inspected using the metrology device based on whether or not the plurality of second process parameter sequences exceed predetermined threshold criteria.

In this refinement, inspection of the second workpiece is not always carried out. Rather, the second workpiece is inspected using a metrology device depending on whether or not the second process parameter sequences exceed predetermined threshold criteria. As long as the second process parameters stay within predefined limits or ranges, specific measurements of the second workpiece can be dispensed with, while the desired product quality is maintained. The predetermined threshold criteria may relate to one or more second process parameter sequences or to selected process parameters recorded while the second workpiece is produced. A virtual measurement of the second workpiece by using the recording of the second process parameters sequences therefore replaces actual real measurements using the metrology device as long as the process parameters sequences are within the predefined limits or ranges. The refinement helps to avoid unnecessary or unproductive measurement runs and thereby further increases the efficiency and the output of the new method and manufacturing installation. In addition, the knowledge database of the new manufacturing installation is updated, if the second process parameter sequences exceed the predetermined threshold criteria.

In another preferred refinement, the plurality of process parameters comprise machine element movement parameters, environmental parameters, machine tool parameters, workpiece material parameters, operator interventions.

Machine element movement parameters may comprise one or more of travel distance, travel speed and/or acceleration. Environmental parameters may comprise one or more of structure-borne sound, airborne sound, ultrasound, temperature, humidity, brightness, vibration and/or noise. Machine tool parameters may comprise one or more of size, type, brand, hours of operation, number of starts, number of stops, quantity of motor drive current, amount of cooling liquid used and/or tool temperature. Workpiece material parameters may comprise one or more of composition, alloy, origin, brand, supplier, batch, storage time before use, material temperature, density, surface roughness. Operator interventions may comprise one or more of the number, duration, instant of time and/or type of operator interventions during a production run. Recording such a variety of process parameters during an actual production run and chronologically matching these process parameters and the control commands provides a very efficient approach for virtual in-process measurements of a workpiece during a production run.

In another preferred refinement, the correction controller comprises a dedicated machine adapter configured to translate the first error correction commands into the plurality of modified first control commands.

In exemplary embodiments, the correction controller comprises one or more processors, preferably in the form of microprocessors as they are commercially available from various firms like Intel, AMD, Analog Devices, ARM, Apple, IBM, Fairchild and many others. The one or more processors may be implemented as Central Processing Units (CPU) and/or Graphical Processing Units (GPU) and may be interconnected with computer memory in the form of RAM and/or ROM and with a variety of interface circuits in any common network architecture. In some exemplary embodiments, the correction controller may have a modular, scalable design using a plurality of processors and communication interfaces, such as MessageBus for communication among the modules. The modules may be implemented using virtual machines and/or container architectures, such as Kubernetes or KubeVirt, which are commonly available under open source rules. Moreover, the functions of the correction controller may be implemented as cloud-based services and/or as a services implemented on edge devices in a distributed computer network. At least one method step at a time may be implemented on at least one processor of the plurality of processors.

The dedicated machine adapter may advantageously be implemented as a dedicated software component executed on the one or more processors. Preferably, another dedicated software component executed on the one or more processors implements a function that is called base level comparator in the following.

The base level comparator preferably (i) maps the plurality of first process parameter sequences onto the plurality of first successive manufacturing steps in order to obtain the first sequential mapping data, (ii) obtains the deviations between the actual workpiece characteristics and the desired workpiece characteristics, and (iii) determines the first error correction commands. The error correction commands may advantageously be generic so that they are largely independent of the specific brand and type of the manufacturing machine and/or the brand and type of the machine controller. The dedicated machine adapter advantageously receives the generic error correction commands from the base level comparator and translates them into the plurality of modified control commands, which are specific for the brand and type of the machine controller actually used for the production of the next workpiece. In other words, generation of the modified control commands may advantageously be split into a first step of determining generic error correction commands and a second step of determining specific modified control commands based on the generic error correction commands. The refinement has the advantage that the new method and manufacturing installation can easier and more efficiently be adapted to various different manufacturing machines and machine controllers. In preferred exemplary embodiments, the base level comparator is generic for a plurality of different manufacturing installations, while the dedicated machine adapter is individually configured for any specific brand and type of manufacturing machine and/or machine controller. By way of example, the machine controller may be a programmable logic controller commercially available by companies such as Siemens, Fanuc, Rockwell, Keyence, Beckhoff and many others.

In another preferred refinement, the manufacturing installation further comprises a metrology sensor adapter configured to generate formatted point cloud data from measurement values obtained by the metrology device, the formatted point cloud data representing the produced workpiece by a plurality of 3D points relative to a predefined coordinate system.

This refinement also makes it easier to implement the new method and manufacturing installation with components from various different suppliers. By way of example, metrology devices that can advantageously be used are commercially provided from a plurality of firms like Carl Zeiss Industrielle Messtechnik GmbH, Hexagon, Mitutoyo, Keyence and others. By way of example, suitable metrology devices may be coordinate measuring machines having contact-type and/or non-contact-type probes and having any one of the well-known frame structures holding the probe moveably relative to the workpiece to be measured. Suitable metrology devices may also be handheld laser scanners, contact-type probes or non-contact-type probes that can be inserted into the tool head receptacle of a machine tool. Each brand and type of metrology device may deliver individual and/or type-specific measurement values. The metrology sensor adapter according to the present refinement is configured to convert the individual and/or type-specific measurement values into a formatted point cloud data. The formatted point cloud data comprises a standardized point cloud data format that is independent of the specific metrology devices used. It allows to interconnect various brands and types of metrology devices to the correction controller and, more particularly, to the base level comparator.

It goes without saying that the aforementioned features and those yet to be explained below can be used not only in the combination specified in each case but also in other combinations or on their own, without departing from the scope of the present invention.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The embodiments of the invention are illustrated in the drawing and will be explained in greater detail in the following description, wherein

FIG. 1 shows a schematic illustration of an exemplary embodiment of the novel manufacturing installation having one manufacturing machine,

FIG. 2 shows a schematic illustration of a further exemplary embodiment of the novel manufacturing installation having a plurality of manufacturing machines,

FIG. 3 shows a flow chart illustrating an exemplary embodiment of the new method,

FIG. 4 shows a plurality of functional modules and resulting data flow in the exemplary embodiments according to FIGS. 1 and 2,

FIG. 5 shows a software architecture in accordance with an advantageous exemplary implementation of the novel method and manufacturing installation,

FIG. 6 shows the data streams and structure between various functional modules in an exemplary embodiment,

FIG. 7 shows a schematic illustration of a manufacturing process where a cylindrical workpiece is machined,

FIG. 8 shows a schematic illustration of an alternative manufacturing process for machining a cylindrical workpiece,

FIG. 9 shows an exemplary embodiment of a machine-integrated measurement de-vice for measuring workpiece deformations during and/or after a machining process, and

FIG. 10 shows a further exemplary embodiment of a machine-integrated measurement device for measuring workpiece deformations during and/or after a machining process.

In the drawings, reference numbers may be reused to identify similar and/or identical elements.

### DETAILED DESCRIPTION

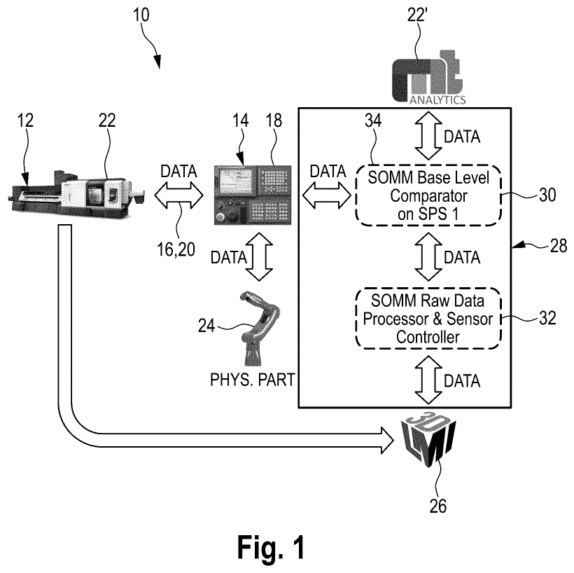

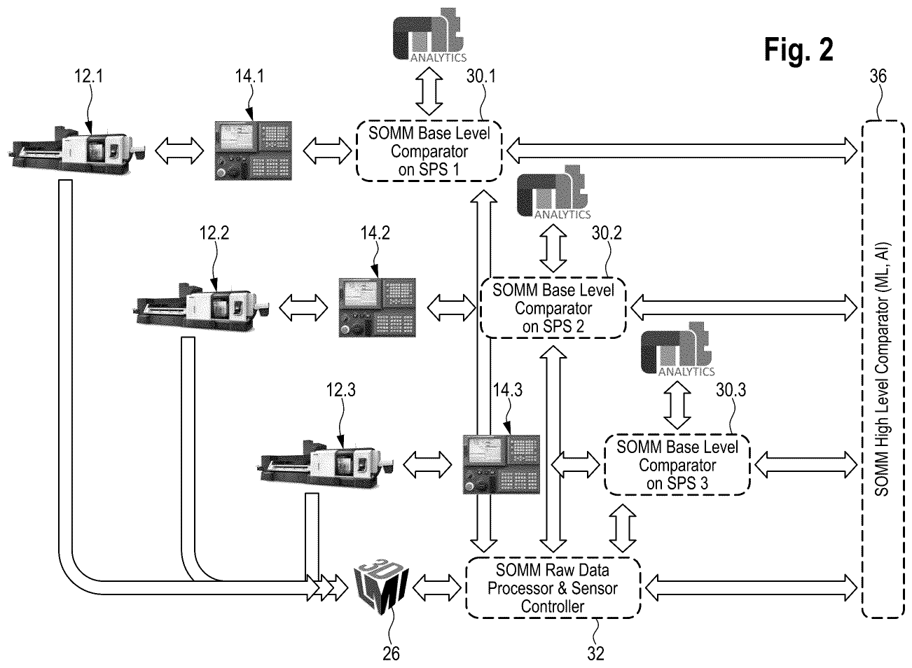

FIGS. 1 and 2 show the basic concept of two advantageous exemplary embodiments for overcoming one or more of the problems mentioned initially. FIG. 1 shows an exemplary embodiment 10 with a manufacturing machine 12 that is controlled by an associated machine controller 14. Manufacturing machine 12 is shown here as a multi-axis machine tool that is capable of at least one of cutting, milling, drilling, turning and/or grinding a workpiece. Suitable machine tools are commercially available from a plurality of providers such as DMG Mori Seiki, Chiron, Heller and many others. Additionally or alternatively, manufacturing machine 12 may be a machine that is capable of welding, bending, pressing or additively manufacturing a workpiece. Without limitation, any type and brand of a controller controlled manufacturing machine that is capable of producing a workpiece from a raw material on the basis of a CAD data set could be used here. All of these manufacturing machines have at least one moveable machine element controlled by machine controller 14, as it is readily known to those skilled in the art. The at least one moveable machine element may be a tool head that carries a cutting tool, milling tool, drilling tool, turning tool, grinding tool, welding tool, bending tool, pressing tool and/or a laser processing tool.

Manufacturing machine 12 and machine controller 14 exchange control data. The control data include, in particular, first control commands as indicated at reference numeral 16. The first control commands are typically determined on the basis of a data set defining desired workpiece characteristics, such as a CAD data set indicated at reference numeral 18 in FIG. 1. A first workpiece (not shown here) is produced during a first production run using the first control commands 16. At a later instant of time, the control data include second control commands 20, with which a second workpiece (not shown here) is produced during a second production run. The second control commands 20 may advantageously be determined in accordance with an exemplary embodiment of the new method, which is explained in more detail further down below. Both the first and second control commands may comprise numerical control parameters. By way of example, a control command may activate a motor driving a moveable machine element and a control parameter included in the control command may specify the amount of the drive current into the motor over the time and/or the travel distance, travel speed etc. of the moveable machine element.

Apart from the first and second control commands 16, 20, the control data may comprise various process parameters 22 recorded using suitable detectors (not shown here for sake of simplicity) in or around the machine installation during a production run. The process parameters 22 may be recorded in the manufacturing machine 12 and/or in the vicinity of manufacturing machine 12, as it is schematically indicated at reference numeral 22′. Process parameters 22, 22′ include machine element movement parameters detected by encoders and/or motor drive currents, for instance, environmental parameters detected by acoustic sensors, temperature sensors, humidity sensors and/or gas sensors, for instance. The process parameters may further include tool parameters such as tool temperature, tool speed, tool wear or motor drive currents; workpiece material parameters such as material density, material components/alloy, surface roughness, grain size; and/or time, type and number of operator interventions during a production run. Suitable detectors for detecting various kinds of process parameters may include machine-integrated sensors, such as encoders, ampere meters, voltage meters, and dedicated process parameter sensors, such as microphones, camera sensors combined with image processing, thermal imaging cameras, optical sensors including laser detectors or laser scanners, vibrometry, thermometers, pyrometers, interferometers, timers and/or counters.

In an exemplary embodiment, manufacturing machine 12 is a multi-spindle machine tool controlled to turn, mill and drill a crankshaft for a bicycle (e-bike) motor. The crankshaft is made from a bar material in a production run of maybe 30s in the exemplary embodiment.

When the production run is finished, the workpiece is removed from the manufacturing machine, preferably by an automated handling system 24, and conveyed for further processing, such as being stacked in pallets. Preferably, automated removal is synchronized with manufacturing machine controller 14. In some exemplary embodiments, controller 14 may therefore exchange further control data with handling system 24 and/or even control handling system 24.

In exemplary embodiments of the new method and manufacturing system, handling system 24 automatically transfers the workpiece produced in the first production run to a metrology device 26. Metrology device 26 may be a coordinate measuring machine (CMM) using a contact-type and/or non-contact-type probe, a computed tomography device, an industrial microscope and/or any other metrology device suitable and configured for inspecting the workpiece with respect to its workpiece characteristics. Optical metrology with cameras and/or laser scanners is particularly attractive in the field of machining, additive manufacturing (3D printing) and other forming processes. Measurement technology and inspection are not limited to dimensional measurement technologies. Other defect detection methods are also conceivable, such as deflectometry, eddy current analysis, surface roughness profilometers, acoustic measurements, etc.

Metrology device 26 is preferably located in the vicinity of manufacturing machine 12 and preferably configured to automatically inspect the workpiece using a predefined inspection plan. In some exemplary embodiments, metrology device 26 may be configured to automatically measure 3D point cloud data of measurement points recorded on the workpiece in order to determine dimensional and/or geometrical characteristics of the workpiece in accordance with the predefined inspection plan. The inspection plan may also be determined on the basis of the CAD data set 18. In other exemplary embodiments, metrology device 26 may be integrated into manufacturing machine 12, or can selectively be introduced into manufacturing machine 12, in order to record measurement values on the workpiece while it is still fixed in the manufacturing machine 12. In yet another exemplary embodiment, metrology device 26 may be a hand-held device, such as a hand-held 3D laser scanner.

In any case, metrology device 26 is a physical inspection system capable of and configured for recording measurement/inspection values on the workpiece, which measurement/inspection values allow to determine actual workpiece characteristics. Preferably, automated test sequences and algorithmic interpretation of the results are implemented, such as DIN-ISO-compliant point cloud evaluation, CAD rule geometry comparisons, form and position evaluations, etc. In some preferred exemplary embodiments, software tools commercially available from Carl Zeiss Industrielle Messtechnik GmbH, Germany, are used, such as the software tools Calypso (for regular geometries), Caligo (for free-form surfaces), Gear Pro (especially for measuring gears), GOM Inspect and/or GOM Volume Inspect.

The novel manufacturing installation 10 further comprises a correction controller 28 that is configured to carry out at least one and preferably more of the method steps explained further down below. In preferred exemplary embodiments, the correction controller 28 is implemented as one or more software components comprising executable software code that is executed on one or more hardware processors in a manner readily known to those skilled in the art. The one or more hardware processors may be commercially available microprocessors from Intel, AMD, Apple, IBM, Fairchild, ARM or others. In some exemplary embodiments, the software components implementing the correction controller 28 may be installed and/or executed on commercially available computer hardware operating one or more of commercially available computer hardware operating systems, such as Windows, Linux, MacOS. In some exemplary embodiments, the software components implementing the correction controller 28 may be installed and/or executed on one or more virtual machines, such as virtual machines based on Hyper-V, Powershell and/or Kybernetes Clusters. The software components implementing the correction controller 28 may be installed on hardware already present in a conventional manufacturing installation, such as the hardware implementing the machine controller 14. By way of example, there are programmable logic controllers (PLCs) acting as machine controllers and implemented on hardware that is similar or even identical with hardware of a conventional personal computer running an operating system like Windows or Unix/Linux. The functionality of the correction controller 28 may also be implemented on such a hardware platform. In yet further exemplary embodiments, the software components implementing the functionality of the correction controller 28 may be installed on cloud computers and/or edge computers of a computer network.

In preferred exemplary embodiments, correction controller 28 comprises a functional module 30 that is called SOMM base level comparator in the following. In the exemplary embodiment shown in FIGS. 1 and 2, the SOMM base level comparator is a software module that implements and/or controls at least one of the method steps of
repeatedly recording the plurality of process parameters during successive manufacturing steps in order to obtain respective process parameter sequences (process parameters over time) for each process parameter of the plurality of process parameters,
mapping the plurality of process parameter sequences onto the plurality of successive manufacturing steps in order to obtain sequential mapping data,
obtaining actual workpiece characteristics and/or measurement values from the metrology device 26,
comparing actual workpiece characteristics obtained from metrology device 26 with the desired workpiece characteristics 18 in order to determine deviations be-tween the actual workpiece characteristics and the desired workpiece characteristics, and
determining a plurality of error correction commands that may be translated into modified control commands for the machine controller 14, such that following manufacturing runs are carried out in a manner such that deviations are reduced and preferably minimized.

By way of example, a cutting tool may be moved a small amount further into the workpiece during machining, when the deviations show that a certain dimension on the workpiece was too long.

The mapping step provides mapping data that chronologically associates each first control command from the plurality of first control commands used in the previous manufacturing run with the process parameters recorded at the time when the respective control commands were executed. The association based on the respective instants of time allows to identify effects that cause or lead to production errors more specifically and individually. Therefore, error correction commands can be determined more selectively than without taking into account the individual history of process parameters and control commands.

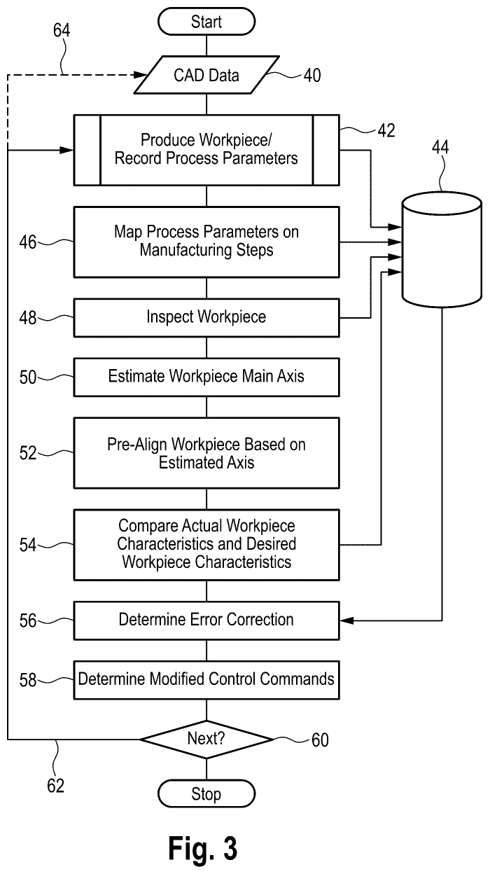

In preferred exemplary embodiments, correction controller 28 comprises a functional module 32 that is called SOMM raw data processor & sensor controller in FIGS. 1 and 2. Software module 32 provides the function of a metrology sensor adapter configured to generate formatted point cloud data in a predefined format from raw measurement values obtained by metrology device 26. The formatted point cloud data preferably represents the produced workpiece by a plurality of 3D points relative to a predefined coordinate system in a standardized form, such that various types and brands of metrology devices 26 may be used and communicate with the SOMM base level comparator 30. Functional modules 30, 32 may exchange data with each other and with machine controller 14 or metrology device 26, respectively, as indicated in FIGS. 1 and 2. Preferably, correction controller 28 further comprises a dedicated machine adapter 34 (cf. FIG. 3) configured to translate the first error correction commands into the plurality of modified control commands for the specific type and brand of machine controller 14 used in the respective manufacturing installation.

FIG. 2 shows an exemplary embodiment of the novel manufacturing installation comprising a plurality of manufacturing machines 12.1, 12.2, 12.3 each being controlled by a respective machine controller from a plurality of machine controllers 14.1, 14.2, 14.3. The plurality of manufacturing machines 12.1, 12.2, 12.3 with the associated plurality of machine controllers 14.1, 14.2, 14.3 may be installed and arranged at one common factory location, such as in one common factory building. In some exemplary embodiments, the manufacturing machines 12.1, 12.2, 12.3 and the respectively associated machine controllers 14.1, 14.2, 14.3 may be located remote from each other in different local regions, cities or even countries, but nevertheless form part of the new manufacturing installation.

By way of example, manufacturing machines 12.1 and 12.2 may be located in close vicinity to each other in a common factory building at one location. Machines 12.1 and 12.2 may be of different age and may have partly different kinematics, such as different series of axes, different dimensions, stiffnesses etc. Third manufacturing machine 12.3 may be located remote from manufacturing machines 12.1 and 12.2 at a different location, such as a different city or country. Manufacturing machine 12.3 may be of a different type and brand, but it is nevertheless capable of producing the same type of workpieces as manufacturing machines 12.1 and 12.2. For a set of workpieces, production may take place on any of manufacturing machines 12.1, 12.2, 13.3. In order to produce a desired number of workpieces in a most efficient manner, a superordinate instance is advantageous in order to decide which machine is best suited to manufacture which type of workpiece at which time.

The superordinate instance is shown here as SOMM high level comparator 36, which receives data from each of SOMM base level comparators 30.1, 30.2, 30.3. The high level comparator 36 may be implemented as a functional software module on any hardware processor or computing device commercially available from Intel, AMD, Apple, IBM, Analog Devices, Fairchild, ARM or others. In some exemplary embodiments, the software components implementing the high level comparator 36 may be installed and/or executed on a commercially available computer hardware operating one or more of commercially available computer hardware operating systems, such as Windows, Linux, MacOS. High level comparator 36 may further be implemented on virtual machines, such as virtual machines based on Hyper-V, Powershell and/or Kybernetes Clusters, on cloud computing devices and/or edge computing devices. Regardless of the specific type of implementation, high level comparator 36 is advantageously configured to dynamically allocate production programs including control commands, operating parameters, corrections etc. on a machine specific and/or location-specific and time-dependent basis. High level comparator 36 may also be configured to determine higher level error correction commands for any of the connected machine controllers 14.1, 14.2, 14.3 on the basis of the sequential mapping data from each of base level comparators 30.1, 30.2, 30.3. In preferred exemplary embodiments, high level comparator 36 may use machine learning techniques, in particular reinforced deep learning techniques and/or artificial intelligence to learn about the cause-and-effect relationships in the manufacturing machines 12.1, 12.2, 12.3 on the basis of the sequential mapping data from each of base level comparators 30.1, 30.2, 30.3. Reinforced deep learning techniques are explained, by way of example, in a publication titled “Simulationsgestützte Auslegung von Reglern mithilfe von Machine Learning” by Dominic Brown and Martin Strube, ARGESIM Report 59 (ISBN 978-3-901608-93-3), p 141-147, DOI: 10.11128/arep.59.a59020, which is incorporated by reference here.

With reference to FIGS. 1 and 2, it may be assumed that manufacturing machine 12 produces a first workpiece. A plurality of successive manufacturing steps are controlled by machine controller 14. In particular, machine controller 14 controls the movements including paths/trajectories of at least one moveable machine element, such as a tool head, in a closed-loop configuration. Typically, the at least one moveable machine element is moveable relative to the workpiece along a plurality of movement axes. When the production is finished, the workpiece is removed from machine 12, which is preferably achieved by handling system 24. Until now, measurements of selected features on the workpiece have been made randomly or systematically on selected ones of a series of produced workpieces. The measurements were used for quality control and typically resulted in an okay/not okay decision. In addition, information could be derived from the measurements as a basis for correcting a subsequent manufacturing run by interpreting any feature deviations.

Heretofore, correction strategies suffer from the fact that they only have access to the cumulative effect of all influences that occurred during the manufacturing run as a result of the measurement of the final state of the workpiece after the production run is finished. In-process variations are typically not detected. Therefore, it would be helpful to have, in addition to the cumulative effect, history information on how the cumulative effect came about. Unfortunately, it is difficult or even impossible to make intermediate measurements on the workpiece during a manufacturing run. By way of example, a crankshaft should not be removed from the manufacturing machine before the end of the production run in order to avoid deteriorating product quality.

Advantageously, intermediate in-process measurements are therefore virtualized. A large number of process parameters including at least some process parameters that are not required for the specific production run, are repeatedly (preferably continuously) recorded during the manufacturing run, as already mentioned above. The recorded parameters are time-stamped and mapped onto the movement trajectory of the at least one moveable machine element and, more particularly, onto the control commands used during the production run. In other words, a kind of logbook is created showing which part of the movement trajectory was traversed with which parameters. Recording and chronologically mapping the plurality of process parameters allows to create a digital process twin. Any detected anomalies in the process parameters can advantageously be used to estimate/predict feature deviations on the workpiece produced. The estimated feature deviations can advantageously be used to determine corrective interventions and, in case of a running production process, a decision to stop the current production run can be made. The latter may be advantageous, for example, in order to save tools and process time if the workpiece seems to be irrecoverably lost anyway, or if machine hazards cannot be ruled out in view of the detected process parameter anomalies.

Depending on the magnitude or nature of the predicted feature deviation, and preferably automatically as a function of predefined anomaly categories, a physical measurement of workpiece features that are potentially affected by the anomalies can be selectively made. The new method and manufacturing installation thus allow to reduce the number of actual measurements on workpieces produced in a series production by selectively carrying out measurements using a metrology device only if process parameter anomalies were detected during the production run. In other words, exemplary embodiments of the new method and manufacturing installation comprise a step of measuring/inspecting a workpiece using metrology device 26 in response to a trigger signal issued by the correction controller 28. Correction controller 28 may be configured to issue the trigger signal in response to an anomaly in the process parameters being detected during the production run. In other words, an event-triggered workpiece inspection using metrology device 26 may be implemented in some exemplary embodiments of the new method and manufacturing installation, with the trigger-event being an anomaly detected in the plurality of process parameters and/or process parameters sequences recorded during the production run of the respective workpiece. The anomaly may be defined as one or more process parameters recorded during the production run exceeding one or more predefined threshold criteria. In turn, physical measurements on a produced workpiece using a metrology device may advantageously be dispensed with as long as the process parameter sequences stay within predefined tolerance intervals.

Notwithstanding, a physical measurement of the workpiece after the production run using a metrology device may advantageously be carried out and serve for validating predicted feature deviations and thus for confirming the predictive capability of the process twin. Preferably, the corrective model using process parameter mapping is maintained and used as long as any additional real measurement results of the workpiece are within the tolerances of the desired workpiece characteristics.

Accordingly, some workpieces of a series of workpieces produced on the manufacturing installation may be measured using metrology device 26 irrespective of whether or not any anomalies in the recorded process parameters or process parameter sequences were detected during the production run, while other workpieces of the series of workpieces are only inspected using metrology device, if anomalies in the recorded process parameters or process parameter sequences were detected during the respective production run. Preferably, the event-triggered workpiece inspection is carried out automatically in response to a trigger signal from correction controller 28. The measurements irrespective of whether or not any anomalies were detected are advantageously used to check that the digital twin is still valid. Model parameters of the digital twin are maintained as long as these measurements confirm a correct error prediction.

If differences between predicted feature deviations and physically measured feature deviations are detected, determining error correction values is preferably be based on the physical measurement results. Therefore, the physical measurement results may be used as a basis for modified control commands.

Advantageously and in the manner described above, the physical metrology device may additionally be used in order to train (“teach-in”) the digital process twin, i.e. in order to determine and, if necessary, quantify model parameters of the correction model.

With continued reference to FIGS. 1 and 2, FIG. 3 shows an advantageous exemplary embodiment of the new method with some key aspects. According to step 40, desired workpiece characteristics are obtained. The desired workpiece characteristics may be defined in a CAD data file including predefined acceptable tolerances for the relevant workpiece characteristics. Based on the desired workpiece characteristics, a first workpiece is produced on a selected manufacturing machine 12, as it is known to those skilled in the art. According to step 42, however, a plurality of process parameters are repeatedly recorded during the successive manufacturing steps. A history of process parameters is thereby obtained parallel to the production process. The plurality of process parameters are stored in a data base or memory 44, which can be a local memory at the location of the manufacturing machine 12 and/or a remote memory, such as a cloud storage or a memory on an edge device.

According to step 48, the first workpiece produced is inspected using a metrology device 26. As explained above, the workpiece inspection may result in a point cloud or point cloud data, respectively, representing the workpiece by a plurality of 3D coordinates relative to a defined coordinate system. 3D point cloud data may also be stored in database 44.

According to step 50, preferably, a workpiece main axis is estimated from the point cloud data and the point cloud data (=actual workpiece data) is pre-aligned based on the estimated main axis according to step 52. The actual workpiece characteristics and the desired workpiece characteristics are compared according to step 54 in order to determine deviations between the actual workpiece characteristics and the desired workpiece characteristics. The comparison may be performed by fitting the pre-aligned point cloud data into the CAD data in some exemplary embodiments, and the deviations may also be stored in database 44. According to step 56, error correction values are determined based on the mapping data from step 46 and the deviations from step 54. According to step 58, modified control commands for a subsequent production run are determined based on the error correction values from step 56. The modified control commands are advantageously used in the production of a second workpiece in accordance with step 60. The second workpiece may be a second workpiece of the same type as the first workpiece produced, as is indicated by loop 62. Alternatively, the second workpiece may be a workpiece of a different type, as is indicated by loop 64. Even if the second workpiece is of a different type, the knowledge gained from the production run producing the first workpiece provides valuable insight into the cause-and-effect relationship between desired workpiece characteristics and actual workpiece characteristics on workpiece produced on the manufacturing installation, for which the chronological mapping data is available.

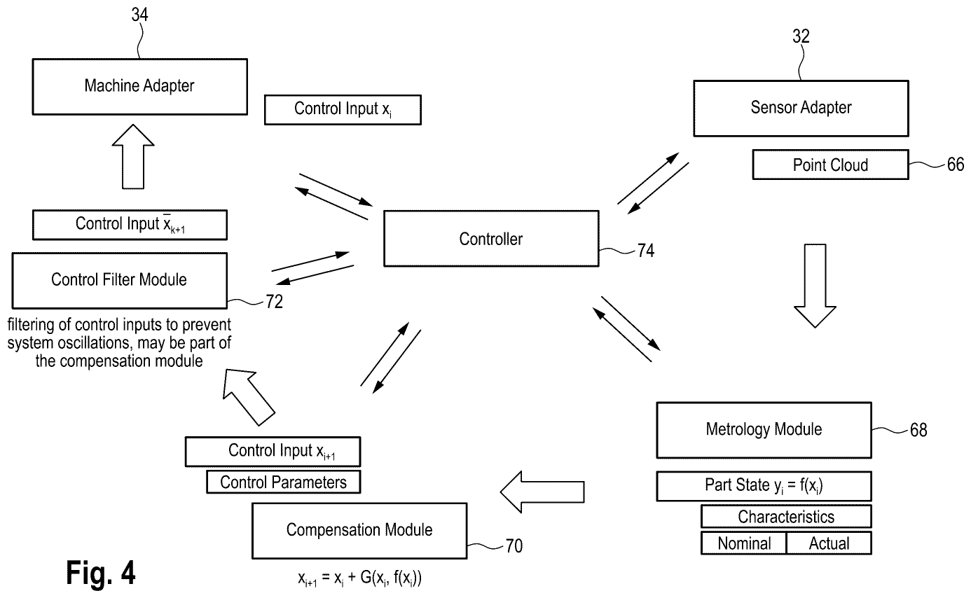

FIG. 4 shows a schematic illustration of an exemplary embodiment of the new method and manufacturing installation. Same reference numbers designate the same elements as before. As has already been explained, a sensor adapter 32 receives actual measurement/inspection data from a metrology device (not shown here) and provides point cloud data 66 to a functional module 68 that is termed here as metrology module. The point cloud data 66 represent a digital image of the workpiece with its actual work-piece characteristics. The point cloud data, which may be in the form of a value list of measurement values and/or coordinates relative to a predefined coordinate system, is delivered to metrology module 68. The metrology module 68 interprets the point cloud data 66 and determines an actual state of the workpiece yi, preferably section by section, as a function f of the process parameters and control commands that were recorded while the workpiece was produced. In other words, metrology module 68 determines an actual state of the workpiece (part state) from the measurement data. The state of the workpiece/part may generally be modelled by a mathematical function of the type

$${y}_{i} = f ( {x}_{i} )$$

with xᵢ representing a vector or an array comprising the plurality of control commands and process parameters recorded over time during the production run i, and f defining a (typically non-linear) function that represents the dependencies between the control commands, process parameters and the actual workpiece characteristics.

A comparison is then made in metrology module 68 between the actual workpiece characteristics and desired workpiece characteristics, which may be in the form of a CAD model (nominal state or nominal characteristics). The comparison generates, preferably workpiece section/region by workpiece section/region, quantified feature deviations of the workpiece. The quantified feature deviations are mapped, preferably again section-by-section, to the sequences of process parameters and control commands, i.e. they are assigned to the process parameters and control commands including control parameters of the respective movement of the moveable machine element that led to the measured feature deviations. Preferably, geometric workpiece features that can be correlated with nominal workpiece features are determined from the point cloud data using a fitting method, such as the least squares method, with the latter preferably being determined from a predefined inspection plan.

Metrology module 68 provides the quantified feature deviations and sequential mapping data to functional module 70, which is termed here as compensation module. The deviations are projected onto process change options that can be applied globally and/or on a section-by-section basis. In other words, compensation module 70 determines error correction commands and/or directly modified control commands for a subsequent production run. Modified control commands may comprise and/or may be modified control parameters, such as parameters leading to a longer movement path or a reduced movement speed. In some exemplary embodiments, a plurality of modified control commands for a subsequent production run are determined on the basis of a function as

$${x}_{i + 1} = {x}_{i} + G ( {x}_{i} , f ( {x}_{i} ) )$$

with xi+1 being a vector or an array comprising the plurality of control commands and control parameters for the next production run i+1, and G representing a (typically non-linear) function that is used for determining the modified control commands/control parameters based on the deviations and previously used control commands and process parameters.

The function G of previous control commands and parameters xi and workpiece status yi may be determined empirically including, by way of example, using machine learning techniques, in particular reinforced deep learning techniques, or analytically as it is generally known to those skilled in the art. The function G determined in this way allows a new control parameter set xi+1 to be determined in such a manner that less or smaller feature deviations are achieved in the subsequent production run compared to feature deviations observed. One general approach for determining the function G is described U.S. Pat. No. 10,180,667, which is incorporated by reference herewith. Other feed-back models based on model replica of the physical processes in a manufacturing machine or based on a black-box approach for the manufacturing machine are also conceivable as feed-back models.

Preferably, the set of modified control commands xi+1 represents a continuously differentiable and small change with respect to the control commands xi. Accordingly, the function G is preferably modeled as a continuously differentiable function. In addition, it is preferred in some exemplary embodiments, if modified control parameters are filtered, as is indicated at functional control filter module 72, before the modified control parameters are transferred to machine controller 14 such that control command changes exceeding a predefined threshold are cancelled in order to avoid an oscillation of the system.

It should be observed that not all control commands have the same error compensation potential. In some cases, a modified control command may include or result in the use of modified G-code variables, such as a different tool diameter and/or different tool length, tool speed or feed of the tool, by way of example. Such a modified control command results in reducing average deviations along the relevant movement path interval. Alternatively or in addition, modified control commands may include a new movement path being generated in order to use all available control parameters as a function of the previously determined feature deviations at the respective path position. In some further cases, environmental parameters, such as temperature, and/or material parameters may be changed.

As mentioned above, efficient calculation methods are preferably used for the comparison of nominal and actual geometries, in particular best-fit methods for fitting CAD geometries into the measured values of the workpiece. Particularly in large-volume production, cycle times often allow only a few seconds for the measurement of the workpiece and corrective interventions to be derived from this (“time to result”). For this reason, calculation methods are preferred, such as described in “Least Squares Orthogonal Distance Fitting of Curves and Surfaces in Space” by Sung Joon Ahn, published by Springer-Verlag under ISSN 0302-9743, ISBN 3-540-23966-9, by way of example, which is incorporated by reference here. As mentioned above, the software packages Calypso and Caligo available from Zeiss Industrielle Messtechnik GmbH, Germany can advantageously be used.

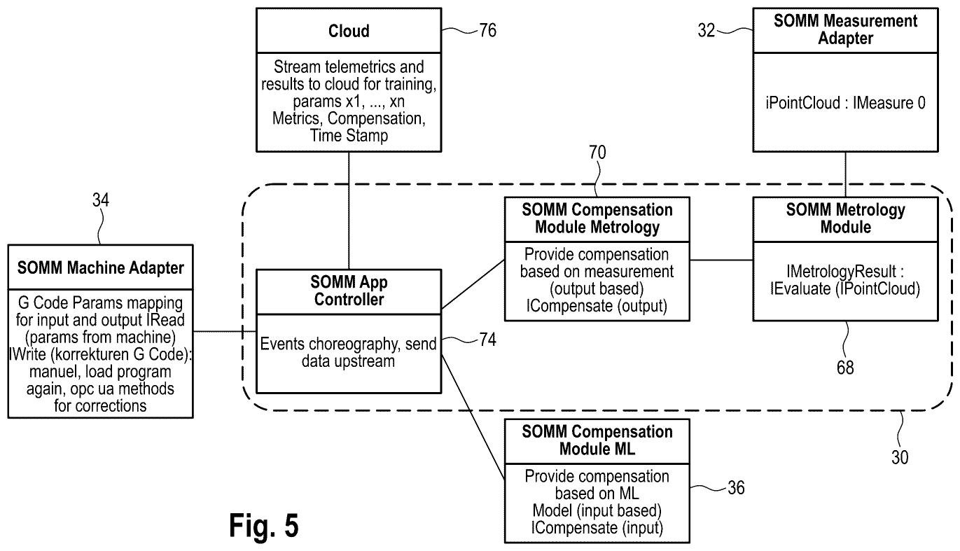

Preferably, processing logic described above may be implemented under the control of a central controller application 74. The central controller application is a functional module that communicates with any of the other functional modules 32, 34, 68, 70, 72. This allows the exchange or update of individual modules while retaining other modules. This can be helpful for adaptation to changing requirements such as changing machining processes. FIG. 5 provides a more detailed illustration of the software architecture of the functional modules. Same reference numbers designate the same elements as before.

As has already been indicated further above, each functional module 32, 34, 68, 70, 72, 74 may be implemented as a software module on a commercially available computing device including personal computers, edge-computers and/or cloud computing devices. Any of these devices may employ microprocessors and memories commercially available from Intel, AMD, Apple and many others.

In FIG. 5, sensor adapter 32 from FIG. 4 is designated as SOMM Measurement Adapter. It corresponds to the SOMM raw data processor and sensor controller 32 in FIG. 1 and generates point cloud data from raw sensor data provided by the metrology device. Metrology module 68, compensation module 70 and app controller module 74 represent the functional modules explained above with respect to FIG. 4. Modules 68, 70 and 74 may be combined into the SOMM base level controller 30.

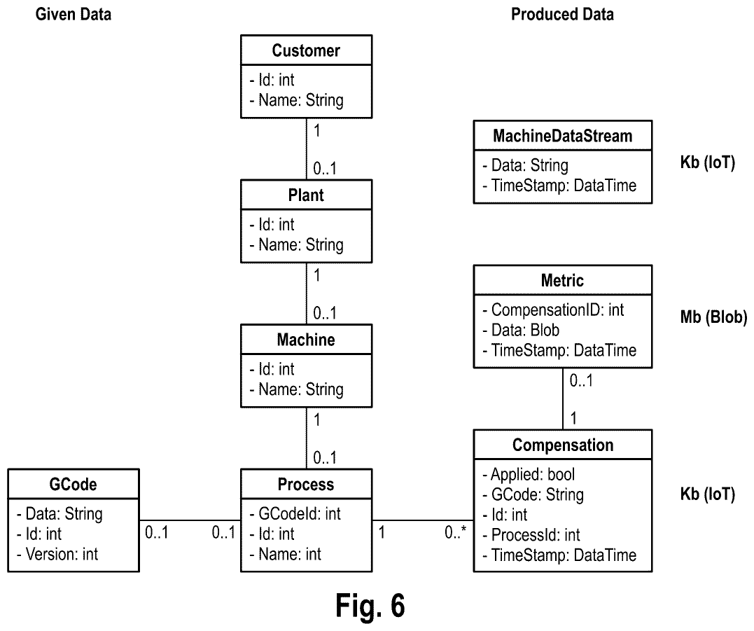

SOMM Compensation Module ML of FIG. 5 corresponds to the SOMM High Level Comparator 36 of FIG. 2. It may advantageously communicate with app controller module 74 in some exemplary embodiments and generate corrected process control parameters on a higher level using data from a plurality of manufacturing machines and respective base level controllers (cf. FIG. 2). FIG. 6 describes the data streams and their structure in an exemplary implementation according to FIG. 5.

In high-precision manufacturing, a fundamental problem is that the performance of machines is increasingly reaching its limits in view of increasingly tighter manufacturing tolerances. Increases in manufacturing accuracy can often only be achieved with massive design effort and resulting high manufacturing costs. At the same time, users and operators of manufacturing installations are increasingly unable to create and maintain stable conditions in their production environment. In practice, this often leads to the discrepancy that, although machine manufacturers specify ambitious characteristic values, these are largely verified under laboratory conditions and are therefore generally not achievable in the customer's production environment. The resulting long run-in times of machines until process capability is proven tie up personnel and cause enormous costs. Sometimes, even after months, it is not clear how great the residual potential for further optimization is and how it can be leveraged at all.

While manufacturers often try to calibrate and compensate for known influencing factors purely on the basis of software, these calibrations are costly and usually limited to a few parameters that are assumed to be dominant in terms of residual errors. However, as the number of parameters increases, the calibration effort increases exponentially and the calibration models become increasingly difficult to handle. This phenomenon is also known as the “curse of dimensionality” and it becomes even more serious if the dimensions are not normalized with respect to each other and, in particular, a Euclidean distance measure is assumed for non-integral dimensions. Moreover, customer-specific influencing factors beyond the manufacturing machine cannot be represented in these calibration models. When machine manufacturers calibrate their machines a priori, they have to do this over the entire parameter space, since it is usually not known how the customer will use the machine. For reasons of economy, however, manufacturing machines are designed in such a way that they can nevertheless be used very flexibly within a typical application area and have a correspondingly large number of degrees of freedom. This characteristic is in turn at odds with robust, universally valid calibration. Manufacturers and customers must therefore decide between flexibility and precision.

The primary interest of users of manufacturing machines is to maintain the manufacturing tolerances for their own range of workpieces. For them, it would therefore be sufficient if only the parameter subspace required for this purpose are calibrated. Depending on the complexity, size and variety of shapes of the workpieces to be produced, relevant value ranges of the machine parameters are similarly large, significantly smaller or even vanishingly small compared to the theoretically possible range of machine parameters. If the machine manufacturer knew a priori which workpieces are to be produced, he could adapt his calibration procedures in such a way that only the required parameter space is calibrated. This can possibly be done with lower dimensionality and higher sampling rates and therefore with presumably lower residual errors. However, the machine manufacturer would still not be able to calibrate influences outside the parameters accessible to him at the factory. For example, a milling machine manufacturer can only predict the changing properties of the milling tools used.

The user of the manufacturing machine does not care about cause-effect relationships as long as his manufacturing tolerances are maintained in the production runs. It is therefore sufficient for him to merely compensate for the effects, regardless of which influences have led to a production error. From a user's point of view, on the other hand, it is by no means necessary to keep machine parameters absolutely constant as long as the manufacturing tolerances are not exceeded. To the contrary, it is often necessary and common practice to react to changing environmental conditions with parameter adjustments.

According to an aspect, it is suggested that manufacturing parameters, which may be represented by control commands and control parameters, are deliberately changed to a predefined (small) extent from one production run to another production run in such a way that it is at least unlikely that manufacturing tolerances will be exceeded. This applies especially for a situation where the workpieces produced in the respective productions runs are basically the same, i.e. share the same desired workpiece characteristics. In other words, it is suggested to deliberately change the manufacturing parameters from one production run to another production run not or not only as a reaction to detected production errors or changed environmental parameters, but proactively in order to add some deliberate process variation. Preferably, such deliberate change of manufacturing parameters is done only after a manufacturing process has been sufficiently established.

In contrast to successive production runs with constant parameters or largely sporadic and reactive adjustments of manufacturing parameters, the proactive change of manufacturing parameters generates a further multi-dimensional data point in the parameter space of the manufacturing process. A corresponding residual vector is created with each workpiece produced. The vector field is subject to constant change if there are factors influencing the quality which are not represented in the parameter space.

According to the user's specifications, the process can now decide to tend to explore the parameter space (cognitive component), e.g., to increase the “catch range” for good parts and thus relax requirements for the stability of machine and process parameters. This can be done randomly, systematically or in all conceivable mixed forms.

However, the procedure can also try to move preferably to the currently known global optimum or, alternatively, as far as possible to the center of the “safe zone” in order to actually produce good parts with a high probability (social component). In both cases, exploration increases the probability of leaving a local optimum in favor of a better optimum.

In practice, it is preferred to set as high as possible an explorative fraction during the process start-up phase in order to find the best possible local optima. In low-interference production operation, on the other hand, the explorative share is significantly smaller, but still necessary in order to be able to react to drifts or abrupt changes in the production conditions without endangering the process stability itself. This behavior is based on the so-called particle swarm optimization and is particularly suitable for nonlinear optimization problems in high-dimensional spaces, where the derivative of the quality function is unknown or can only be calculated with very high effort.

The information obtained by the targeted exploration of the parameter space can be further used in one or more ways: Identify parameters with particularly critical influence on process stability; Identify parameters with lower influence on process stability with the aim of relaxing requirements on machine and process; Identify correlations between parameters for the purpose of improved model building; Identify correlations between machine parameters and residual vectors to better understand cause-and-effect relationships; As a measure of the predictability of the behavior of a given machine (systematic vs. stochastic errors); Reduce manufacturer and customer calibration effort; Quantify non-modeled influencing factors (movement and deformation of the “safe zone” over time) versus modeled influencing factors to evaluate the goodness of the model; Comparison of identical or similar machines, machine types and/or production environments with regard to process capability and compensability; Deepen the understanding of the production process or process twin by examining commonalities and differences of the residual vector fields or their characteristics on different machines, machine types and/or manufacturing environments.

As has already been explained further above, the problems or potential problems are not always fully predictable in many manufacturing processes and environments. Thus, it is difficult to implement efficient, fully automated monitoring systems that perform a quality check when unforeseen process or environmental parameters have occurred that may have led to a tolerance violation. Typically, tolerance violation is detected late or not at all in an individual sample. According to another aspect of the present disclosure, an interface is provided that allows humans to provide additional anomaly detection capabilities in a running manufacturing process in such an efficient way that it can be used for process control even in one-off manufacturing flows.

One preferred procedure is as follows: A portable metrology device is inserted into the manufacturing machine using a sufficiently reproducible change interface of the machine kinematics. The operator selectively carries out a measurement of a newly created workpiece surface. In the process, he manually defines measuring regions on the workpiece, in which regions should be measured at all. Subsequently, the measuring machine repeats the manually defined test sequence on the very same workpiece and thus generates an actual point cloud of the workpiece. This point cloud or associated point cloud data reflects the actual state of the effect of all influences acting on the manufacturing process, i.e. a direct relationship is established between the resulting workpiece properties and the existing machine or process conditions. Based on the comparison of the nominal condition of the workpiece with its measured actual condition, following machining steps can be corrected, i.e. pre-compensated. If necessary, e.g. in additive manufacturing, past processing errors can be reworked before further processing is carried out in a precompensated manner.

If the reproducibility of the change interface for the applicable CMM is insufficient or its error contribution is eliminated, measurements of a machine coordinate system reference may be measured in addition to workpiece feature measurements. The machine coordinate system reference may permanently installed or selectively brought into the manufacturing machine for the measurement, in particular together with the workpiece.

Accordingly, the change interface for an insertable CMM may located on the workpiece or on a carrier carrying the workpiece. These approaches would allow to create a 6D location reference between the respective manufacturing machine and a workpiece at each machining station where the workpiece is fed into, while also quantifying process variation influences without having to shield sensitive measurement technology from harsh machining environments.

In some exemplary embodiments, a trigger signal to a machine operator may come from the High Level Comparator, which may guide the machine operator or process manager to take a look at certain features to see if there are any problems. This can advantageously be used to check whether there is actually a machining problem. And the manually performed measurement can be used to derive an inspection plan to be subsequently included in the series inspection plan repertoire. In summary, a portable metrology device may advantageously be used during an actual manufacturing run in response to a trigger signal from the High Level Comparator, such that a specific measurement of a selected workpiece feature or workpiece region can be initiated, while the workpiece is still being kept in the manufacturing process and, in particular, in the manufacturing machine.

Moreover, workpiece regions at which subsequent measurements are later carried out, when the workpiece is removed from the manufacturing machine, could be specified in the manner described above. In the sense that initially accessible workpiece features or regions are measured with interchangeable measurement technology (such as shape deviations with low single point probing density). Based on this, an inspection plan for a later measurement of the workpiece may be determined, including trajectory specification and optionally using a different sensor technology. Such later measurement may advantageously be used to selectively inspect or measure workpiece characteristics that are not accessible to the interchangeable sensor technology.

On the other hand, an operator may selectively initiate a measurement in a workpiece region, within which, in the opinion of the machine operator, previously unobserved process deviations with a possible tolerance violation might have occurred. If necessary, the process, machine and environmental parameters recorded in this workpiece region can be compared by the High Level Comparator with all-time series of all processes and locations in order to generate a prognosis as to whether the observed parameter combination entails an increased probability of error occurrence, and if so, with regard to which workpiece region or feature. Advantageously, the manufacturing method and installation may be updated using this knowledge. By way of example, a comparison with workpieces in the process history from the past may be made by the High Level Comparator and an instruction message may be issued to the operator, such as, by way of example: “In the past, there were similar parameter constellations to the part you are currently concerned about. These were the parts XXX1, XXX101, XXX102, XXX203 of location X as well as the records YYY1 to YYY223 and YYV24 to YYV440 of location Y. Better check them all again!”

The described interfacing functions may advantageously be implemented using a mobile device. By way of example, a workpiece recognition or workpiece position detection could be implemented and executed on the mobile device in order to facilitate the definition of potentially problematic workpiece regions by the operator, such as by using a GUI with a touch-sensitive screen.

In modern constructions, it is more and more desired to have workpieces with thin walls, i.e. smaller wall thicknesses are increasingly desired for reasons of weight and cost. In this respect, workpieces increasingly show similarities with “sheet metal structures”. However, some of these structures cannot be bent, deep-drawn, welded, etc. from sheet metal because these processes do often not support the geometric complexity of the workpiece or required materials do not permit the process. Consequently, workpiece materials are sometimes machined using methods that are not well suited for the desired wall thickness. Sometimes, thin-walled constructions are supplied as thin-walled semi-finished products or near-net-shape workpieces (e.g. from additive manufacturing or casting), and are then to be brought into a final state according to the design by a machining process. Machining forces, clamping forces, gravitational forces, evasive movements of workpiece walls during machining and other effects can then lead to undesired results in terms of workpiece quality. Predefined tolerances are difficult to achieve.

An approach suitable for industrial manufacturing to solve these problems may involve linking adaptive modeling for workpiece and process behavior, as well as the physical measurement technology required for this, to quantify the error budget-consuming effects sufficiently accurately and quickly. This is described in an exemplary embodiment further down below.

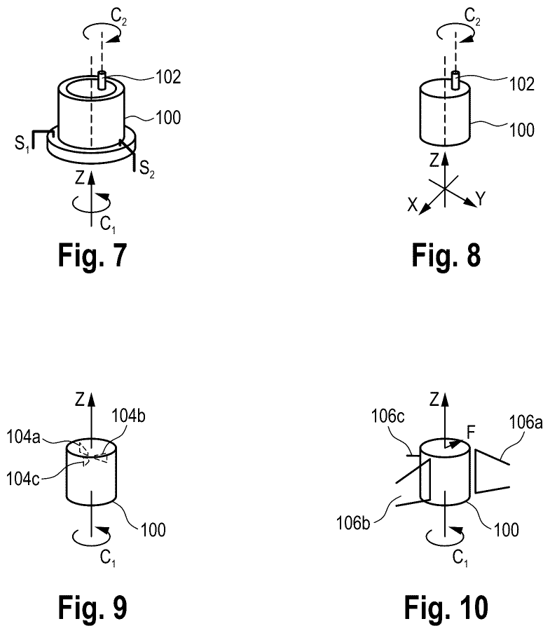

FIG. 7 illustrates the problem in a representative manner and shows a workpiece 100 clamped by two exemplary clamping claws S1 and S2. Any number and any type of clamping devices may be used, such as magnetic clamping, vacuum clamping or variable needle chucks. The clamped workpiece 100, in this exemplary case a hollow cylinder or tube, is fed for machining to a tool 102 rotating about axis C2, which is shown here in the z-direction. During machining, the workpiece may also rotate about axis C1, as exemplified here. In FIG. 8, the same machining strategy is implemented by different axis movements. Instead of rotating the workpiece 100 around the C1 axis, the tool engagement point is now displaced along the inner wall of the workpiece by moving the workpiece in the x and y axis directions. The z-displacement remains as in FIG. 1.

During machining according to FIG. 7, the machining forces always act in the same direction in relation to the machine coordinate system. Assuming a rotary bearing with radial rigidity independent of the angle of rotation, the machining process runs stably in the sense that the tool displacement does not fluctuate due to process and machine properties for a circular motion in a plane perpendicular to C1.

However, varying stiffness results for different circular planes, i.e. z-feed. This will typically be necessary if machining the inside of the cylinder is not possible in one pass. Typically, tools with single cutting edges on large flying circles are used here, with which the inner surface is spindled out along an e.g. helical path. But planar machining would also be conceivable. The stiffnesses would thus vary either continuously (helical machining) or stepwise (plane-by-planar machining). Machining with this machining strategy would be demanding, but it could presumably be “learned” in order to find a suitable machining process on prototypes and pre-series lots in an iterative procedure with mutually determining design changes to the component and associated changes to the machining strategy.

Quality monitoring for the process developed in this way could be carried out by means of measurement technology, preferably integrated into the machine, as indicated in FIG. 9. FIG. 9 shows examples of optical triangulation sensors 104a, 104b, 104c, such as line triangulation sensors in the form of laser line scanners. Exemplary 3D optical sensors could be such as those offered by the company LMI Technologies under the name Gocator. FIG. 9 shows a frequently desired case where full-area digitization of the internally machined surface is desired, i.e. the surface shape is to be determined over a spatial wavelength interval, for which tactile measurement technology is less preferred for productivity reasons.

The triangulation sensors shown here, which are preferably arranged crossed, span a coordinate system independent of the machine, within which the workpiece geometry and, if necessary, also surface properties can be measured, provided that the so-called intrinsic and extrinsic calibration is sufficiently stable. The physical measuring principle used is irrelevant. It is only important that the quantity, arrangement and type of sensors are suitable for generating 3D point cloud data of sufficient point density and point accuracy and at the highest possible speed. Therefore, in addition to high-speed triangulation sensors, digital holography, confocal measurement principles (optical confocal sensors) or femtosecond laser systems are also conceivable. It is also conceivable to carry out the measurement by means of a sensor system that scans the relevant workpiece surfaces and/or uses deflecting optics. This can be particularly advantageous for expensive sensor systems, as they are then only required once. The approach can also have advantages for optics to be protected. The sensors may be integrated and permanently installed, or they can be designed with wireless power and data transmission for mounting in the tool spindle or another interchangeable interface on the machine. These features and approaches can be combined to equip a machining center with measurement technology that is advantageously used to lower the so-called time-to-result compared with established (tactile) measuring room solutions. This enables shorter process development and process monitoring even for process fluctuations in the production cycle.

Another preferred measurement approach is illustrated in FIG. 10. Without loss of generality, it may be assumed that the workpiece has a complex 3D geometry that is to be machined. It further has a complicated spatial stiffness profile and may have quasi-reflective surfaces at the end of machining. As illustrated by FIG. 10, the sensor technology may be arranged on the outside. On the surface, which is often rough anyway and may otherwise be matted by suitable treatment (such as spraying), optical 3D measurement methods can be used very well. This would make it possible to directly measure the real response of the workpiece shape to applied forces (machining and/or acceleration and/or weight force). In one exemplary embodiment, machining forces may be selectively applied to the inside of the workpiece and any resulting deformation of the workpiece in response to the machining forces is measured from the outside. The resulting measurement data may advantageously be supplied to the High Level Comparator and be used in order to optimize the manufacturing of a plurality of workpieces, as explained further above.

In the manner described above, the workpiece displacement can be measured of a first specimen and can advantageously be used in determining second control commands and control parameters. Advantageously, thermal imaging sensors can also be used to detect thermally induced workpiece deformations in the machining process.

In some exemplary embodiments, machine integrated measurement technology may be used only initially to evaluate anomalies in advance of a series production process and to update the process twin accordingly, if necessary. Series production advantageously uses precompensated second control commands/parameters in such a manner that the workpieces produce are within the desired tolerances.

In one preferred embodiment, a method is proposed for producing a plurality of workpieces using a manufacturing installation that comprises a first manufacturing machine having a first moveable machine element, a first machine controller configured to control the first moveable machine element, and a metrology device configured to determine actual characteristics of a produced workpiece, the method comprises the steps of
obtaining a data set defining desired workpiece characteristics of the plurality of workpieces,
producing a first workpiece from the plurality of workpieces in a plurality of first successive manufacturing steps using the first manufacturing machine, wherein the first machine controller controls the first moveable machine element along a plurality of first movement paths using a plurality of first control commands determined on the basis of the data set,
inspecting the first workpiece using the metrology device during the producing in order to obtain actual first workpiece characteristics under machining loads,
comparing the actual first workpiece characteristics with the desired workpiece characteristics in order to determine deviations between the actual first workpiece characteristics and the desired workpiece characteristics,
determining a plurality of second control commands on the basis of the deviations, and on the basis of at least one of the plurality of first control commands and the data set, and
producing a second workpiece from the plurality of workpieces using the manufacturing installation and the plurality of second control commands.

In another preferred embodiment, a method is proposed for producing a plurality of workpieces using a manufacturing installation that comprises a first manufacturing machine having a first moveable machine element, a first machine controller configured to control the first moveable machine element, and a metrology device configured to determine actual characteristics of a produced workpiece, the method comprises the steps of
obtaining a data set defining a unitary set of desired workpiece characteristics for each of the plurality of workpieces,
producing a first workpiece from the plurality of workpieces in a plurality of first successive manufacturing steps using the first manufacturing machine, wherein the first machine controller controls the first moveable machine element along a plurality of first movement paths using a plurality of first control parameters determined on the basis of the data set,
deliberately modifying at least one first control parameter from the first control parameters in order to determine a plurality of second control parameters, which differ from the first control parameters in the at least one first control parameter,
producing a second workpiece from the plurality of workpieces using the manufacturing installation and the plurality of second control parameters,
inspecting the first workpiece using the metrology device in order to obtain actual first workpiece characteristics,
inspecting the second workpiece using the metrology device in order to obtain actual second workpiece characteristics, and
comparing each of the actual first workpiece characteristics and actual second workpiece characteristics with the desired workpiece characteristics in order to determine deviations,
determining a plurality of further control commands on the basis of the deviations, and on the basis of at least one of the plurality of first control parameters, the plurality of second control parameters and the data set, and
producing further workpieces from the plurality of workpieces using the manufacturing installation and the plurality of further control parameters.

Accordingly, control parameters, especially numerical control parameters, and control commands comprising such control parameters, are deliberately changed to a predefined (small) extent from one production run to another production run, preferably in a manner such that it is unlikely that manufacturing tolerances will be exceeded. In other words, it is suggested to deliberately change manufacturing parameters from one production run to another production run not or not only as a reaction to detected production errors or changed environmental parameters, but proactively in order to add deliberate process variation. Preferably, such deliberate change of manufacturing parameters is done only after a manufacturing process has been sufficiently established.

It goes without saying that corresponding manufacturing installations are within the scope of this disclosure.

The term non-transitory computer-readable medium does not encompass transitory electrical or electromagnetic signals propagating through a medium (such as on a carrier wave). Non-limiting examples of a non-transitory computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The term “set” generally means a grouping of one or more elements. The elements of a set do not necessarily need to have any characteristics in common or otherwise belong together. The phrase “at least one of A, B, and C” should be construed to mean a logical (A OR B OR C), using a non-exclusive logical OR, and should not be construed to mean “at least one of A, at least one of B, and at least one of C.” The phrase “at least one of A, B, or C” should be construed to mean a logical (A OR B OR C), using a non-exclusive logical OR.

1. A method for producing a plurality of workpieces using a manufacturing installation that includes a first manufacturing machine having a first moveable machine element, a first machine controller configured to control the first moveable machine element, and a metrology device configured to determine actual characteristics of a produced workpiece, the method comprising:
obtaining a data set defining desired workpiece characteristics of the plurality of workpieces;
producing a first workpiece from the plurality of workpieces in a plurality of first successive manufacturing steps using the first manufacturing machine, wherein the first machine controller controls the first moveable machine element along a plurality of first movement paths using a plurality of first control commands determined based on the data set;
repeatedly recording a plurality of first process parameters during the plurality of first successive manufacturing steps in order to thereby obtain a respective first process parameter sequence for each first process parameter of the plurality of first process parameters;
mapping the plurality of first process parameter sequences onto the plurality of first successive manufacturing steps in order to obtain first sequential mapping data, the first sequential mapping data associating each first control command from the plurality of first control commands with first process parameters recorded at a time when the respective first control command was executed;
inspecting the first workpiece using the metrology device in order to obtain actual first workpiece characteristics;
comparing the actual first workpiece characteristics with the desired workpiece characteristics in order to determine deviations between the actual first workpiece characteristics and the desired workpiece characteristics;
determining a plurality of second control commands based on the deviations, at least one of the plurality of first control commands and the data set, and the first sequential mapping data; and
producing a second workpiece from the plurality of workpieces using the manufacturing installation and the plurality of second control commands.

2. The method of claim 1 wherein:
the manufacturing installation includes a second manufacturing machine having a second moveable machine element and a second machine controller configured to control the second moveable machine element, and
the second workpiece is produced using the second manufacturing machine and the second machine controller.

3. The method of claim 2 wherein:
the first manufacturing machine is located at a first manufacturing site and the second manufacturing machine is located at a second manufacturing site remote from the first manufacturing site,
individual process parameter sequences are recorded separately on the first and second manufacturing sites, and
the plurality of second control commands are determined based on the individual process parameter sequences from both the first and second manufacturing sites.

4. The method of claim 3 further comprising:
producing a third workpiece from the plurality of workpieces on either the first manufacturing machine or the second manufacturing machine,
wherein an individual process decision is made in order to assign the step of producing the third workpiece to either the first manufacturing machine or the second manufacturing machine, and
wherein the individual process decision is based on the individual process parameter sequences from both the first and second manufacturing sites.

5. The method of claim 1 wherein the inspecting includes transferring the first workpiece from the manufacturing machine to the metrology device using an automated handling apparatus.

6. The method of claim 1 wherein:
the inspecting includes generating formatted 3D point cloud data representing a plurality of measurement points on the first workpiece, and
the comparing includes fitting a CAD representation of the first workpiece into the formatted 3D point cloud data using a best-fit algorithm.

7. The method of claim 6 wherein:
a workpiece main axis of the first workpiece is estimated, and
the formatted 3D point cloud data is pre-aligned prior to the fitting using the workpiece main axis.

8. The method of claim 6 wherein:
a plurality of different inspection plans are assigned to different areas of the formatted 3D point cloud data, and
the plurality of different inspection plans are executed in parallel.

9. The method of claim 6 wherein determining the plurality of second control commands includes:
partitioning at least one of the 3D point cloud data and the first workpiece into a plurality of workpiece partitions, and
determining respective second control commands for each of the workpiece partitions separately.

10. The method of claim 1 wherein producing the second workpiece includes:
recording a plurality of second process parameter sequences during a plurality of second successive manufacturing steps,
selecting a subset of second control commands from the plurality of second control commands at a time when the subset of second control commands has not yet been executed during the plurality of second successive manufacturing steps,
modifying the subset of second control commands based on the plurality of second process parameter sequences in order to obtain modified second control commands, and
controlling the moveable machine element using the modified second control commands.

11. The method of claim 10 wherein producing the second workpiece is terminated if it is determined that the modified second control commands exceed a predetermined threshold criterium.

12. The method of claim 1 wherein the second workpiece is inspected using the metrology device event-triggered based on whether or not the plurality of second process parameters exceed predetermined threshold criteria.

13. The method of claim 1 wherein the plurality of process parameters include machine element movement parameters, environmental parameters, machine tool parameters, workpiece material parameters, and operator interventions.

14. A manufacturing installation for producing a plurality of workpieces, the manufacturing installation comprising:
a first manufacturing machine having a first moveable machine element;
a first machine controller configured to control the first moveable machine element in order to produce a workpiece in a plurality of first successive manufacturing steps, wherein the first machine controller controls the first moveable machine element along a plurality of first movement paths using a plurality of first control commands determined based on a data set defining desired workpiece characteristics;
a plurality of first process parameter detectors configured to record a plurality of first process parameters during the plurality of first successive manufacturing steps in order to thereby obtain a respective first process parameter sequence for each process parameter of the plurality of first process parameters;
a first correction controller associated with the first machine controller; and
a metrology device configured to determine actual characteristics of a produced workpiece,
wherein the first correction controller includes at least one processor configured to:
map the plurality of first process parameter sequences onto the plurality of first successive manufacturing steps in order to obtain first sequential mapping data, the first sequential mapping data associating each first control command from the plurality of first control commands with first process parameters recorded at a time when the respective first control command was executed,
obtain deviations between the actual workpiece characteristics and the desired workpiece characteristics,
generate first error correction commands based on the deviations and the first sequential mapping data, and
determine a plurality of modified control commands for the first machine controller based on the first error correction commands.

15. The manufacturing installation of claim 14 further comprising a second manufacturing machine having a second moveable machine element, a second machine controller configured to control the second moveable machine element during a plurality of second successive manufacturing steps, and a second correction controller associated with the second machine controller,
wherein the second correction controller is configured to:
obtain and map a plurality of second process parameter sequences onto the plurality of second successive manufacturing steps in order to obtain second sequential mapping data, and
determine a plurality of modified second control commands for the second machine controller based on the second sequential mapping data.

16. The manufacturing installation of claim 15 further comprising a high level comparator operationally connected with the first correction controller and the second correction controller,
wherein the high level comparator is configured to determine higher level error correction commands for the first machine controller and for the second machine controller based on the first sequential mapping data and the second sequential mapping data.

17. The manufacturing installation of claim 15 wherein the correction controller includes a dedicated machine adapter configured to translate the first error correction commands into the plurality of modified first control commands.

18. The manufacturing installation of claim 15 further comprising a metrology sensor adapter configured to generate formatted point cloud data from measurement values obtained by the metrology device, the formatted point cloud data representing the produced workpiece by a plurality of 3D points relative to a predefined coordinate system.

19. A computer program product comprising program code stored on a non-transitory data storage medium and configured to carry out a method, when the computer program code is executed on at least one processor of a manufacturing installation including:
a first manufacturing machine having a first moveable machine element,
a first machine controller configured to control the first moveable machine element in order to produce a workpiece in a plurality of first successive manufacturing steps, wherein the first machine controller controls the first moveable machine element along a plurality of first movement paths using a plurality of first control commands determined based on a data set defining desired workpiece characteristics,
a plurality of first process parameter detectors configured to record a plurality of first process parameters during the plurality of first successive manufacturing steps in order to thereby obtain a respective first process parameter sequence for each process parameter of the plurality of first process parameters,
a first correction controller associated with the first machine controller, and
a metrology device configured to determine actual characteristics of a produced workpiece,
the method comprising:
obtaining a plurality of first process parameter sequences recorded during a plurality of first successive manufacturing steps with which a first workpiece is produced, the plurality of first successive manufacturing steps being controlled by a plurality of first control commands executed on a manufacturing controller associated with the at least one processor;
mapping the plurality of first process parameter sequences onto the plurality of first successive manufacturing steps in order to obtain first sequential mapping data, the first sequential mapping data associating each first control command from the plurality of first control commands with first process parameters recorded at a time when the respective first control command was executed by the manufacturing controller;
obtaining deviations between actual workpiece characteristics of the first workpiece and desired workpiece characteristics for the first workpiece;
generating error correction commands based on the deviations and the first sequential mapping data; and
providing the error correction commands to the manufacturing controller.
